(19) United States
(12) Patent Application Publication
(10) Pub. No.: US 2026/0200025 A1
(43) Pub. Date: Jul. 16, 2026

(54) TOOL MAGAZINE SYSTEM WITH STACKED TOOL HOLDERS

(71) Applicants: CHEN SOUND INDUSTRIAL CO., LTD., TAICHUNG CITY (TW); HAO-CHUNG LEE, TAICHUNG CITY (TW)

(72) Inventors: HAO-CHUNG LEE, Taichung City (TW); Ho-Hsun Tsai, Taichung City (TW)

(21) Appl. No.: 19/445,682

(22) Filed: Jan. 12, 2026

(30) Foreign Application Priority Data
Jan. 15, 2025 (TW) 114101673

(51) Int. Cl. B23Q 3/155

(52) U.S. Cl. CPC B23Q 3/15506; B23Q 3/15539; B23Q 2003/15537

(57) ABSTRACT

A tool magazine system with stacked tool holders, which is applied to a machine tool, includes a tool storage device, a tool changing device, and a tool storage vertical movement device. The tool storage device has a first and a second tool storages area arranged in parallel, each being configured to accommodate a plurality of tool holders in a stacked manner. A tool holder returning position and a tool holder picking position are provided at the lower end of the first and the second tool storage areas, respectively. The tool storage vertical movement device drives the tool holders in the first and the second tool storage areas to perform vertical movement, delivering the tool holders from the tool holder returning position into the first tool storage area, and from the second tool storage area to the tool holder picking position, facilitating tool changing operations.

### BACKGROUND OF THE DISCLOSURE

### 1. Field of the Disclosure:

The present disclosure relates to tool magazine systems of a machine tool, and more particularly, to a tool magazine system with stacked tool holders and facilitating rapid exchange of tool holders.

### 2. Description of the Related Art:

In order to improve machining efficiency, conventional machine tools are commonly equipped with a tool changing arm and a tool magazine, so as to perform the exchange operation between a machining tool disposed on a spindle and a machining tool stored in the tool magazine via the tool changing arm. However, conventional tool magazines occupy a large amount of space with a relatively complex structure, and are not applicable to multi-spindle machine tools. Also, such tool magazines usually lack multi-directional tool changing capability as well as the ability to accommodate tool holders of different specifications.

Further, tool magazines of multi-spindle machine tools are usually disposed at a rear side or a lateral side of the machine tool, resulting in a long tool changing travel and an extended tool changing time. Moreover, the number of storable machining tools is limited.

For example, CN105873720A discloses a tool magazine independently disposed at a lateral side of a worktable and divided into a machine frame area and an automatic tool changing (ATC) area. However, such a tool magazine still occupies a large amount of space and has a relatively complex structure.

Therefore, the present disclosure provides a tool magazine system with stacked tool holders, which allows machining tools to be exchanged according to the number of spindles of the machine tool, the tool holder specifications, and the tool changing directions of the spindles.

### SUMMARY OF THE DISCLOSURE

To improve the issues above, the present disclosure provides a tool magazine system with stacked tool holders, which is configured to store machining tools in a stacked manner, so as to reduce the space occupied by the tool magazine on the machine tool, simplify the tool holder exchange operation, and rapidly perform the exchange of unused and used tool holders, thereby reducing the time required for machining tool exchange. Moreover, a rotation driving device is allowed to be additionally installed on the engagement frame of the tool changing device as needed, and tool clamps of the same or different specifications are allowed to be accommodated according to machining requirements, further enhancing the versatility and flexibility of the present disclosure.

For achieving the aforementioned objectives, an embodiment of the present disclosure provides a tool magazine system with stacked tool holders, which is applied to a machine tool having at least one spindle and a working area, with a tool changing position formed below the spindle in the working area, the tool magazine system with stacked tool holders comprising:

a tool storage device, comprising at least one first tool storage area and at least one second tool storage area, the first tool storage area and the second tool storage area being arranged in parallel, each of the first tool storage area and the second tool storage area being configured to accommodate a plurality of tool holders in a stacked manner, an open lower end of the first tool storage area forming a tool holder returning position, an open lower end of the second tool storage area forming a tool holder picking position; and

at least one tool storage vertical movement device disposed on the lateral side of the tool storage device, configured to drive the tool holders in the first tool storage area and second tool storage area to perform vertical movement, so as to deliver the tool holders from the tool holder returning position into the first tool storage area, and deliver the tool holders from the second tool storage area to the tool holder picking position, thereby allowing a tool changing device to transport the tool holders between the tool changing position, the tool holder returning position, and the tool holder picking position.

Also, when the spindle requires tool changing in different directions, for example, when a side-mounted head is installed on the spindle, a rotation driving device is allowed to be added on the engagement frame of the tool changing device to rotate the tool holder, thereby achieving the multi-directional tool changing operation.

In an embodiment of the present disclosure, the upper ends of the first tool storage area and the second tool storage area are in communication with each other, with a tool storage horizontal movement device disposed thereon. The tool storage horizontal movement device is configured to drive the tool holders to move at the upper ends of the first tool storage area and the second tool storage area.

In an embodiment of the present disclosure, the tool storage horizontal movement device comprises a horizontal movement power cylinder. The horizontal movement power cylinder has an actuating rod connected thereto. The actuating rod is configured to drive the tool holders to move at the communicated portion of the upper ends of the first tool storage area and the second tool storage area.

In an embodiment of the present disclosure, the tool storage device further comprises a frame, which is disposed to cover an outer periphery of the first tool storage area and the second tool storage area. The frame is provided with at least one first clearance groove and at least one second clearance groove on a lateral side of the first tool storage area and the second tool storage area.

In an embodiment of the present disclosure, each tool holder comprises a seat body disposed on two sides thereof and a plurality of tool clamps disposed between the seat bodies. The tool clamps are configured to movably fix a machining tool thereon. Also, the tool clamps are allowed to be the same or different specifications according to actual requirements, so as to fix machining tools of the same or different specifications.

In an embodiment of the present disclosure, the seat body comprises an engagement protrusion, at least one locking hole, and at least one actuating block, wherein the engagement protrusion has at least one protrusion latching hole and a retaining hole.

In an embodiment of the present disclosure, the tool storage vertical movement device comprises at least one driving cylinder disposed at a lateral side of the frame, and a vertical movement seat driven by the driving cylinder to perform vertical movement. The vertical movement seat is disposed adjacent to the first clearance groove and the second clearance groove.

In an embodiment of the present disclosure, an extension block is disposed on the vertical movement seat corresponding to the first clearance groove. The extension block is configured to extend from the first clearance groove into the first tool storage area to movably abut against the actuating block of the tool holder.

In an embodiment of the present disclosure, the frame comprises at least one locking device disposed on a lateral side of the first tool storage area. The locking device is configured to movably engage the locking hole of one of the tool holders in the first tool storage area. The locking device is an elastically retractable wedge block device.

In an embodiment of the present disclosure, the vertical movement seat comprises a power locking device disposed corresponding to the second clearance groove. The power locking device is a power cylinder having a shaft end configured to extend from the second clearance groove to movably engage the locking hole of one of the tool holders in the second tool storage area.

In an embodiment of the present disclosure, the frame has a stop edge disposed adjacent to the tool holder picking position of the second tool storage area, allowing the actuating block of the tool holder at the tool holder picking position to movably abut against the stop edge.

With such configuration, the tool magazine system of the present disclosure is able to store machining tools in a stacked manner. In cooperation with the tool storage vertical movement device, the tool holders in the first tool storage area and the second tool storage area are driven to move vertically, such that the tool holders are delivered from the tool holder returning position to the first tool storage area, and from the second tool storage area to the tool holder picking position. Such a configuration not only reduces the complexity and precision requirements of the tool storage moving structure and lowers cost, but also allows the tool changing device to transport the tool holders between the tool changing position, the tool holder returning position, and the tool holder picking position, thereby quickly completing the exchange of used tool holders and unused tool holders and further reducing the time required for a tool changing operation.

### BRIEF DESCRIPTION OF THE DRAWINGS

FIG. 1 is a perspective view of the tool magazine system with stacked tool holders in accordance with an embodiment of the present disclosure applied to a machine tool.

FIG. 2 is a partially exploded view of the tool magazine system with stacked tool holders in accordance with an embodiment of the present disclosure.

FIG. 3 is a perspective and partially enlarged view of the tool changing device and the tool holder in accordance with an embodiment of the present disclosure.

FIG. 4 is a schematic view illustrating the movement of the tool changing device in accordance with an embodiment of the present disclosure.

FIG. 5 is a partial perspective operational schematic view of the tool storage vertical movement device in accordance with an embodiment of the present disclosure.

FIG. 6 is a sectional operational schematic view taken along the first clearance groove, illustrating the ascending movement of the tool storage vertical movement device.

FIG. 7 is a sectional view of the transverse movement device in accordance with an embodiment of the present disclosure.

FIG. 8 is a partially sectional operational schematic view taken along the second clearance groove, illustrating the descending movement of the tool storage vertical movement device.

FIG. 9 is a perspective view of the tool changing device disposed on the worktable in accordance with an embodiment of the present disclosure.

FIG. 10 is a partially enlarged perspective view of the tool changing device provided with a rotation driving device in accordance with an embodiment of the present disclosure.

FIG. 11 is a perspective view of the tool changing device provided with a rotation driving device in accordance with another embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

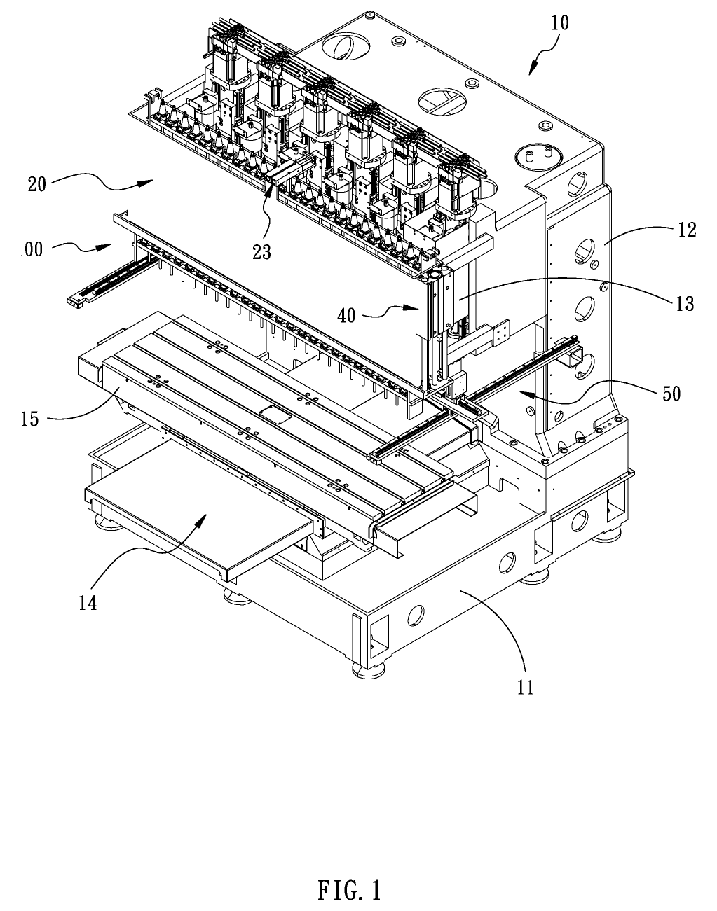

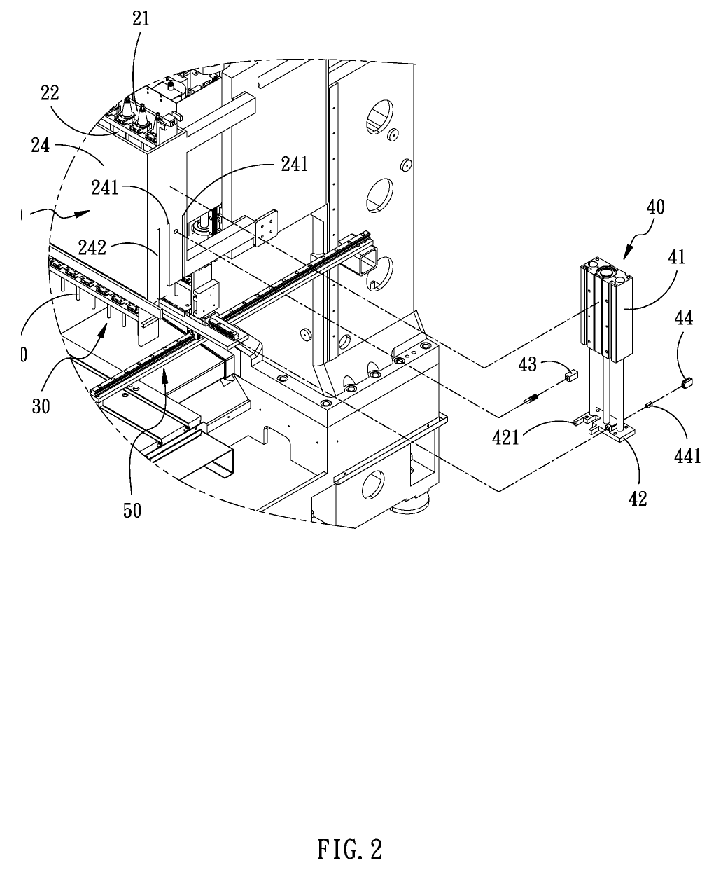

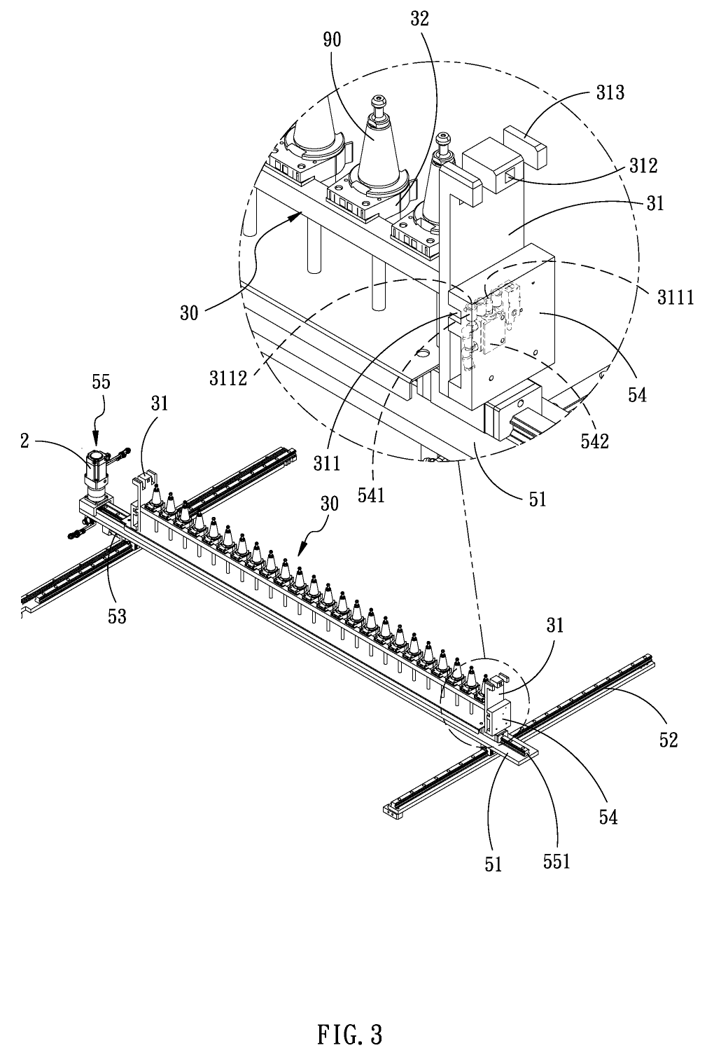

Referring to FIG. 1 to FIG. 4, the present disclosure provides a tool magazine system 100 with stacked tool holders, which is applied to a machine tool 10. The machine tool 10 has a machine base 11 and a column 12 disposed on the machine base 11. The column 12 has at least one spindle 13. A working area 14 for machining a workpiece is formed between an upper portion of the machine base 11 and the spindle 13, with a worktable 15 disposed within the working area 14. Therein, a tool changing position 16 is provided within the working area 14 corresponding to the position of the spindle 13, and the spindle 13 is movable toward or away from the tool changing position 16. The tool magazine system 100 comprises a tool storage device 20 and at least one tool storage vertical movement device 40.

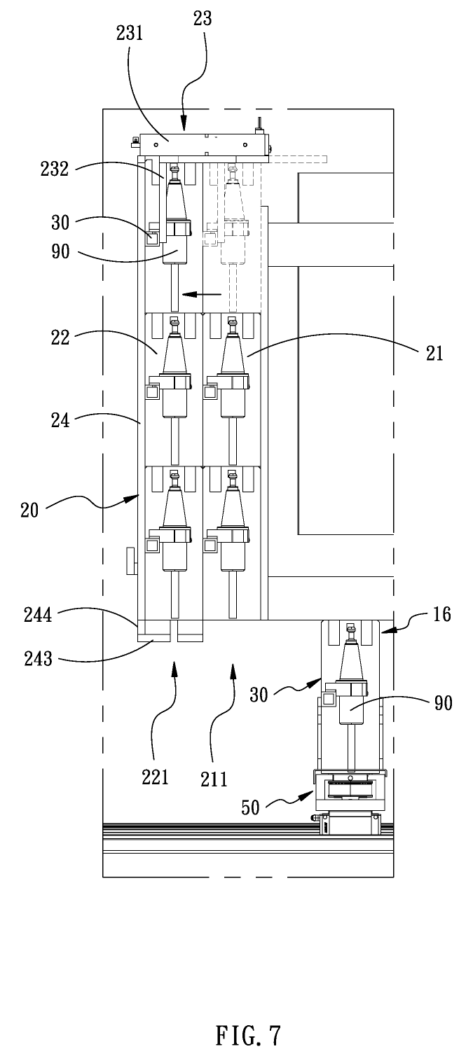

In an embodiment, the tool storage device 20 is disposed above the working area 14 in front of the spindle 13. In other embodiments, when the column 12 is a gantry-type column, the tool storage device 20 is allowed to be disposed on another side of the column 12 opposite to the spindle 13. The tool storage device 20 comprises at least one first tool storage area 21 and one second tool storage area 22, wherein the first tool storage area 21 and the second tool storage area 22 are arranged in parallel, and the first tool storage area 21 is arranged closer to the spindle 13 than the second tool storage area 22 (as shown in FIG. 7). A plurality of tool holders 30 are accommodated within the first tool storage area 21 and the second tool storage area 22 in a stacked manner. Therein, the first tool storage area 21 has an open lower end forming a tool holder returning position 211, and the second tool storage area 22 has an open lower end forming a tool holder picking position 221.

Furthermore, an upper end of the first tool storage area 21 and an upper end of the second tool storage area 22 are in communication with each other, with a tool storage horizontal movement device 23 provided thereon. The tool storage horizontal movement device 23 is configured to drive the tool holders 30 to move at the upper ends of the first tool storage area 21 and the second tool storage area 22. In an embodiment, the tool storage horizontal movement device 23 comprises a horizontal movement power cylinder 231, and the horizontal movement power cylinder 231 is connected to an actuating rod 232, wherein the actuating rod 232 is configured to drive the tool holders 30 to move at the communicating upper ends of the first tool storage area 21 and the second tool storage area 22.

Further, the tool storage device 20 comprises a frame 24, which is disposed to cover the outer periphery of the first tool storage area 21 and the second tool storage area 22. The frame 24 comprises at least one first clearance groove 241 and at least one second clearance groove 242 on a lateral side of the first tool storage area 21 and the second tool storage area 22.

The tool holder 30 comprises a seat body 31 disposed at two sides thereof, respectively, and a plurality of tool clamps 32 disposed between the seat bodies 31. The tool clamp 32 is configured to movably fix a machining tool 90 thereon. Each seat body 31 comprises an engagement protrusion 311, at least one locking hole 312, and at least one actuating block 313 disposed on the outer side thereof. In a preferred embodiment, the engagement protrusion 311 is horizontally disposed and protrudes outward from the outer side of the seat body 31 near the middle portion thereof. Therein, the engagement protrusion 311 further comprises at least one protrusion latching hole 3111 and at least one retaining hole 3112. Therein, two actuating blocks 313 are included, and disposed on the upper end of the outer side of the seat body 31 and protrude outward. The locking hole 312 is arranged between the two actuating blocks 313. Furthermore, the frame 24 comprises a stop edge 243 disposed adjacent to the tool holder picking position 221 of the second tool storage area 22 (as shown in FIG. 7) for the actuating blocks 313 of the tool holder 30 at the tool holder picking position 221 to engage. Also, the frame 24 comprises a positioning block 244 (as shown in FIG. 7), which is configured to serve as a supporting and positioning stop during exchange of the tool holder 30.

The least one tool storage vertical movement device 40 is disposed on a lateral side of the tool storage device 20, and configured to drive the tool holders 30 in the first tool storage area 21 and the second tool storage area 22 to perform vertical movement, such that the tool holders 30 are delivered from the tool holder returning position 211 to the first tool storage area 21, and from the second tool storage area 22 to the tool holder picking position 221, thereby allowing a tool changing device 50 to transport the tool holders 30 between the tool changing position 16, the tool holder returning position 211, and the tool holder picking position 221. The tool storage vertical movement device 40 comprises at least one driving cylinder 41 disposed on the lateral side of the frame 24, and a vertical movement seat 42 driven by the driving cylinder 41 to perform vertical movement. The vertical movement seat 42 is disposed adjacent to the first clearance groove 241 and the second clearance groove 242. The vertical movement seat 42 has an extension block 421 corresponding to the first clearance groove 241. The extension block 421 is configured to extend from the first clearance groove 241 into the first tool storage area 21, so as to movably abut against the actuating block 313 of the tool holder 30.

The frame 24 comprises at least one locking device 43 disposed on a lateral side of the first tool storage area 21, The locking device 43 is configured to movably engage with a locking hole 312 of one of the tool holders 30 in the first tool storage area 21. The locking device 43 is an elastically retractable wedge block device, which has an end formed in a wedge-shaped inclined surface with a longer upper side and shorter lower side. Also, the wedge block device has an elastic force normally pushing toward the first clearance groove 241, such that when the tool holder 30 in the first tool storage area 21 moves upward, the wedge surface of the locking device 43 is subjected to a force and elastically retracted, allowing the tool holder 30 to pass smoothly. In contrast, when the tool holder 30 in the first tool storage area 21 moves downward, the locking device 43 engages with the locking hole 312 of the tool holder 30 to prevent the downward movement of the tool holder 30, thereby allowing the tool holder 30 to move only unidirectionally upward within the first tool storage area 21.

The vertical movement seat 42 comprises a power locking device 44 corresponding to the second clearance groove 242. The power locking device 44 is a power cylinder having a shaft end 441 configured to extend from the second clearance groove 242 to be movably engaged with the locking hole 312 of one of the tool holders 30 in the second tool storage area 22.

In addition, the tool changing device 50 comprises a sliding seat 51, which comprises at least a slide rail 52 and a driving device 53 to drive the sliding seat 51 to move on the slide rail 52. An engagement frame 54 is disposed on two sides of the sliding seat 51, respectively. The engagement frame 54 is configured to be movably engaged with the engagement protrusions 311 of the tool holders 30. The engagement frame 54 comprises at least one engagement device 541 and a locking hole cylinder 542, wherein the shaft of the locking hole cylinder 542 is configured to movably extend into a protrusion latching hole 3111 on the engagement protrusion 311, thereby ensuring a secure engagement between the engagement protrusion 311 and the engagement frame 54. The engagement device 541 is allowed to be a spring plunger. When the engagement frame 54 is engaged with the engagement protrusion 311 of the tool holder 30 and the locking hole cylinder 542 is not engaged with the protrusion latching hole 3111 of the engagement protrusion 311, the engagement device 541 elastically engages with the retaining hole 3112 to provide an engagement force, thereby preventing the tool holder 30 from disengaging. Also, the engagement device 541 is allowed to be a magnetic device, which provides an engagement force by magnetically attracting the engagement protrusion 311.

In other embodiments, a transverse movement device 55 is disposed between the sliding seat 51 and the slide rail 52. The transverse movement device 55 comprises a transverse slide rail 551 and a transverse driving device 552, allowing the tool changing device 50 to drive the tool holder 30 to perform transverse movement. Accordingly, when the tool changing device 50 drives the tool holder 30 to the tool changing position 16, the transverse movement device 55 transversely moves to align different tool clamps 32 with the spindle 13, allowing the spindle 13 to pick up or return the machining tool 90 from and to different tool clamps 32. Furthermore, in other embodiments, the tool changing device 50 is allowed to be additionally provided with a loading/unloading device (not shown) for handling workpieces, or provided with a chip blowing device (not shown) for cleaning the worktable 15 or fixtures thereon, thereby enhancing the functionality of the present disclosure.

With the foregoing configuration, operation of the present disclosure will be illustrated below.

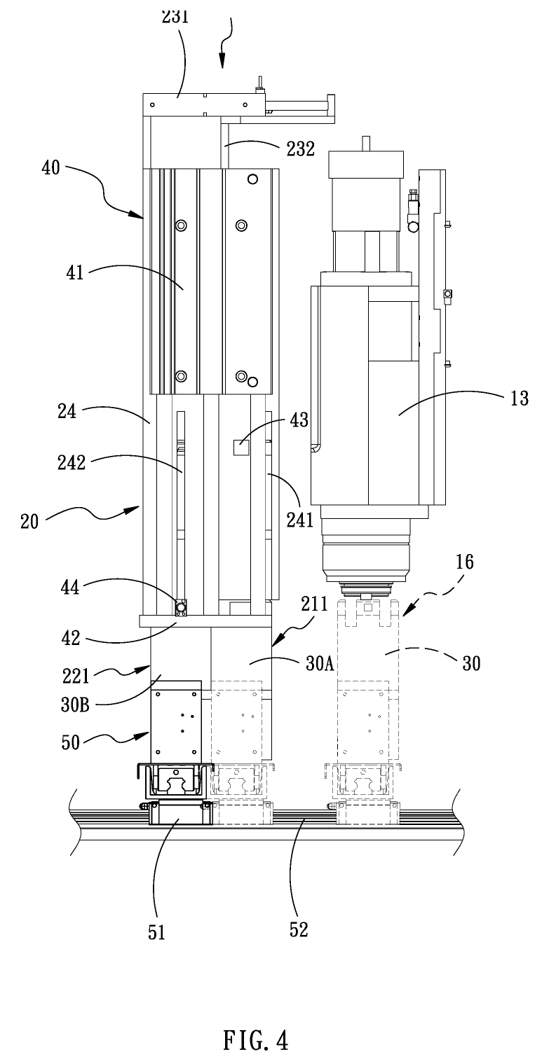

Referring to FIG. 4 in view of FIG. 1 to FIG. 3, in a preferred embodiment, the tool changing position 16, the tool holder returning position 211, and the tool holder picking position 221 are arranged on the same horizontal plane. When the tool changing device 50 drives the tool holder 30 to move to the tool changing position 16, the spindle 13 is allowed to slidably approach or move away from the tool changing position 16, in coordination with the operation of the tool changing device 50, pick up or return the machining tool 90.

When the machining tool 90 of the tool holder 30 has been used, after the tool changing device 50 and the spindle 13 complete the returning operation, the locking hole cylinder 542 releases the tool holder 30 holding the to-be-replaced machining tool 90 (hereinafter referred to as the used tool holder 30 A). At this time, the used tool holder 30A is elastically engaged by the engagement device 541.

Simultaneously with the foregoing operation, the vertical movement seat 42 of the tool storage vertical movement device 40 descends to the lower end of the tool storage device 20. At this time, the extension block 421 on the vertical movement seat 42, and the tool holder 30 holding a new machining tool 90 (hereinafter referred to as the unused tool holder 30 B) and being locked and supported by the power locking device 44, are also brought to the lower end of the tool storage device 20.

Then, the shaft end 441 of the power locking device 44 retracts to be disengaged from the locking hole 312 of the unused tool holder 30B, causing the actuating block 313 of the unused tool holder 30B to be stopped by the stop edge 243.

After the completion of the two aforementioned operations, the tool changing device 50 returns the used tool holder 30A to the tool holder returning position 211 and continues to move toward the tool holder picking position 221. During this process, because the used tool holder 30A is pushed by the unused tool holder 30B, and the unused tool holder 30B is supported by the positioning block 244, the used tool holder 30A slides out of the engagement frame 54 and remains at the tool holder returning position 211 and is abutted by the extension block 421. As the tool changing device 50 moves toward the tool holder picking position 221, the engagement frame 54 again slidably engages the engagement protrusion 311 of the unused tool holder 30B.

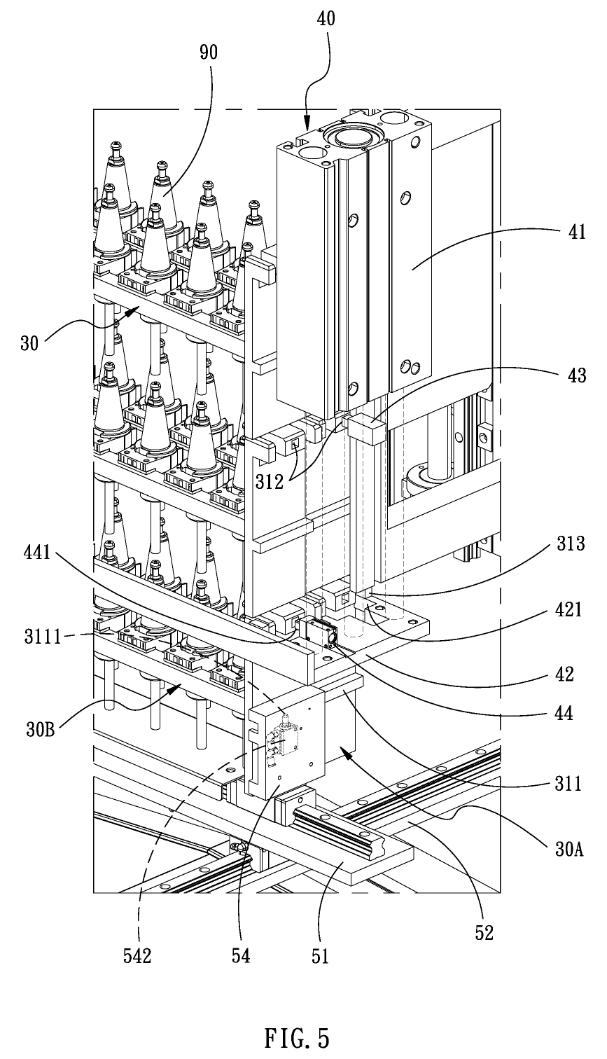

Subsequently, as shown in FIG. 5, the locking hole cylinder 542 of the engagement frame 54 ascends to lock the unused tool holder 30B, while the driving cylinder 41 drives the vertical movement seat 42 to move upward. Previously, the extension block 421 of the vertical movement seat 42 was abutting against the actuating block 313 of the used tool holder 30A, so that the used tool holder 30A is then driven by the vertical movement seat 42 to move from the tool holder returning position 211 into the first tool storage area 21, and the unused tool holder 30B, which is engaged with the engagement frame 54 of the tool changing device 50, remains at the tool holder picking position 221.

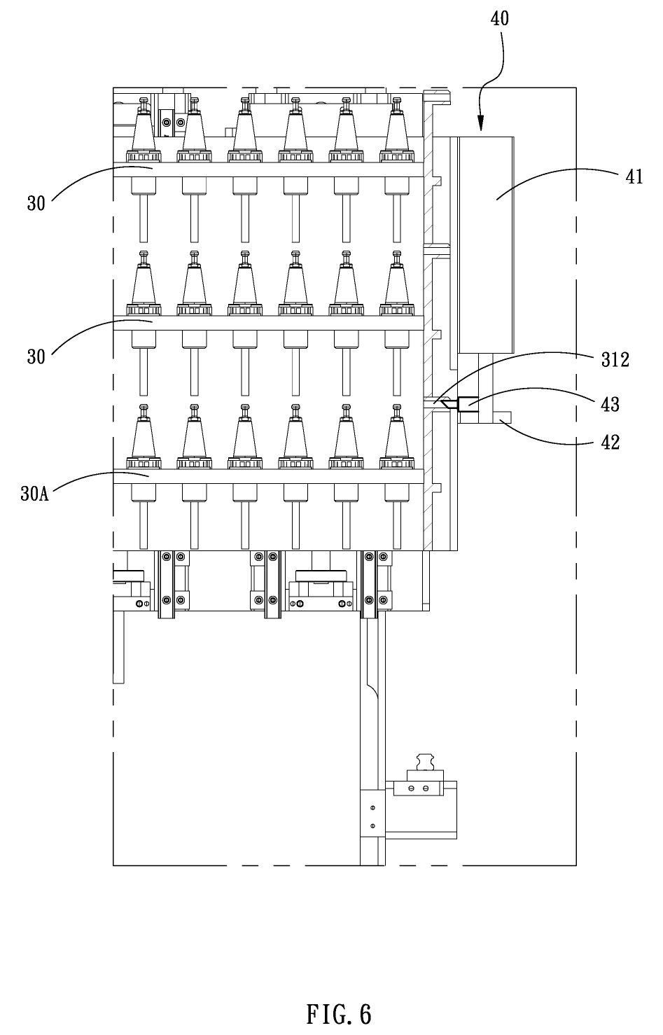

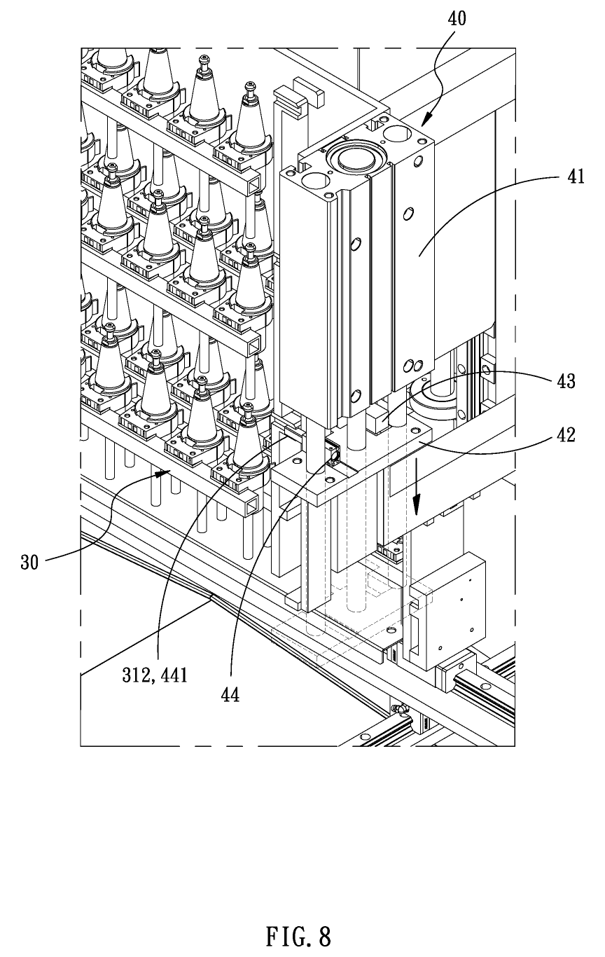

Referring to FIG. 6, when the tool storage vertical movement device 40 drives the used tool holder 30A to move upward, the locking hole 312 of another tool holder 30 above automatically disengages from the locking device 43 in the forward direction. Since the height of each upward movement of the tool storage vertical movement device 40 is approximately equal to the height of a tool holder 30, the locking hole 312 of the used tool holder 30A is re-engaged with the locking device 43, so as to remain within the first tool storage area 21 and prevent the downward movement of the tool holder 30 therein. At the same time, after the upward movement, the power locking device 44 of the vertical movement seat 42 is aligned with the locking hole 312 of a tool holder 30 above the unused tool holder 30B, and the shaft end 441 of the power locking device 44 is driven to extend into the locking hole 312 (as shown in FIG. 8), so as to maintain the positional height of the tool holder 30. Meanwhile, the unused tool holder 30B at the tool holder picking position 221 is in a free state, and is allowed to be driven by the tool changing device 50 to move toward the tool changing position 16, thereby providing a new machining tool 90 for the spindle 13 to perform tool changing operation.

Referring to FIG. 7, after the upward movement, the tool holder 30 in the first tool storage area 21 is one tool holder 30 higher than that in the adjacent second tool storage area 22. At this time, the actuating rod 232 of the tool storage horizontal movement device 23 abuts against the uppermost tool holder 30 in the first tool storage area 21. When the horizontal movement power cylinder 231 drives the actuating rod 232 to move toward the second tool storage area 22, the actuating rod 232 is able to drive the uppermost tool holder 30 to move from the first tool storage area 21 to the second tool storage area 22. Subsequently, referring to FIG. 8, since the shaft end 441 of the power locking device 44 engages the locking hole 312 of the lowermost tool holder 30 in the second tool storage area 22, when the vertical movement seat 42 moves downward again, the lowermost tool holder 30 in the second tool storage area 22 is delivered to the tool holder picking position 221, so as to be ready for the next tool picking operation by the tool changing device 50.

Notably, since the number of tool clamps 32 on the tool holder 30 is allowed to be set as a multiple of the number of spindles 13 to increase the number of tools carried by the tool holder 30, and with the transverse movement device 55, different tool clamps 32 are allowed to be aligned with the spindle 13 as needed. Accordingly, by retrieving the tool holder 30 from the tool storage device 20 only once, the spindle 13 is allowed to perform multiple tool changing operations, thereby further reducing the time required for tool changing operations. Furthermore, since the tool holder returning position 211 is normally idle (without tool holders 30), the tool holder returning position 211 is allowed to serve as a buffer area, so that the tool holder 30 holding the machining tool 90 that have not yet been used up is able to be temporarily moved to the tool holder returning position 211, thereby avoiding interference with the processing spindle 13. At the same time, no buffer zone needs to be additionally provided between the tool holder returning position 211 and the tool changing position 16, so that the travel length of the tool changing device 50 is shortened, thereby further reducing tool changing time and travel distance.

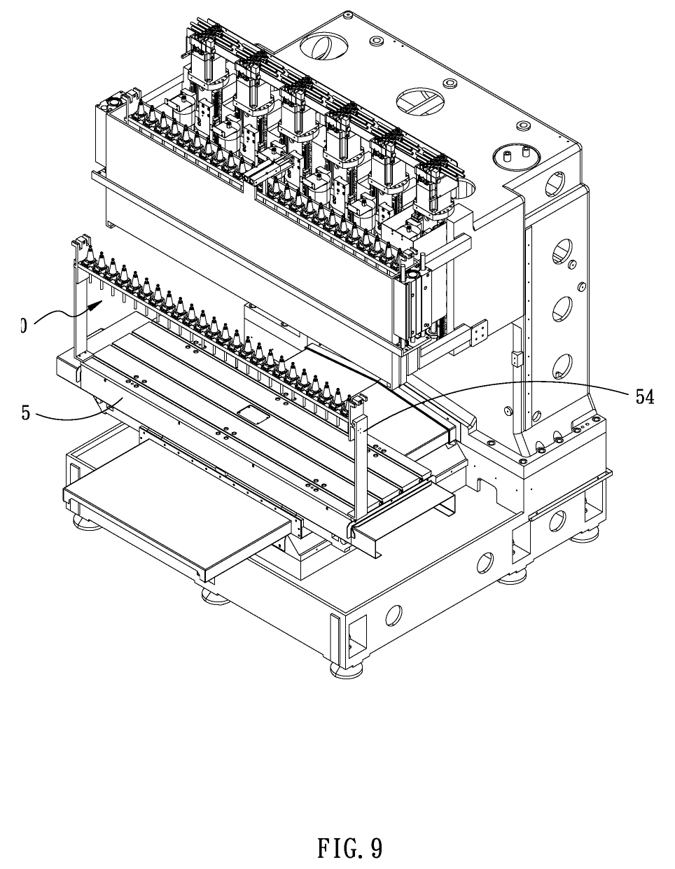

Moreover, referring to FIG. 9, in other embodiments, the engagement frame 54 of the tool changing device 50 is also allowed to be directly disposed on the worktable 15 and driven by the worktable 15 to move between different positions to achieve the tool exchange purpose.

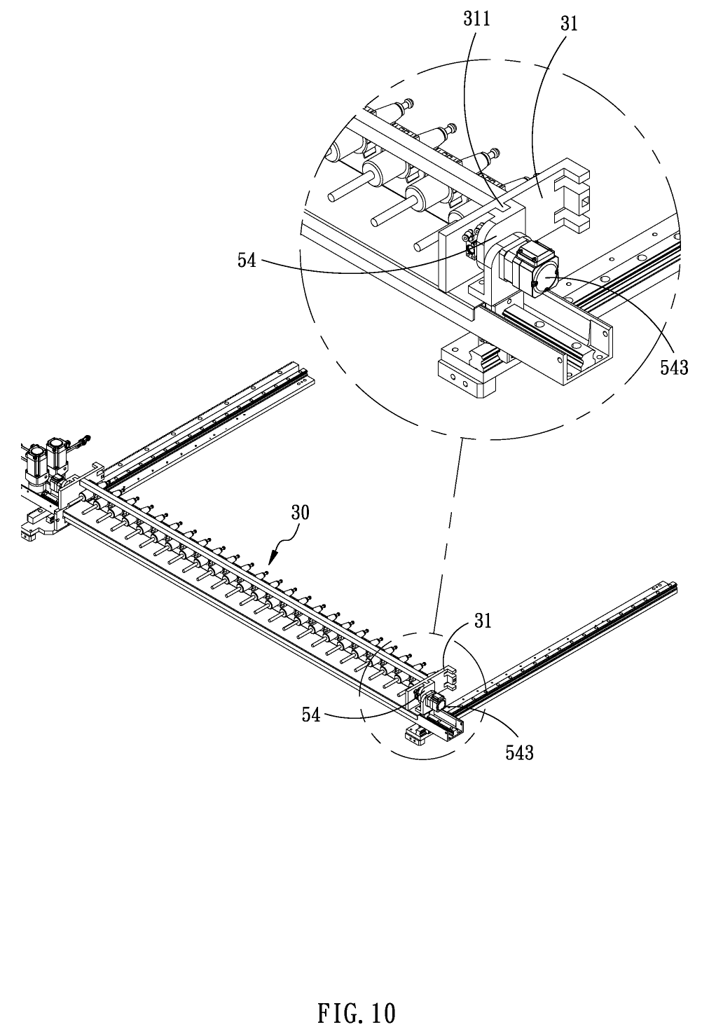

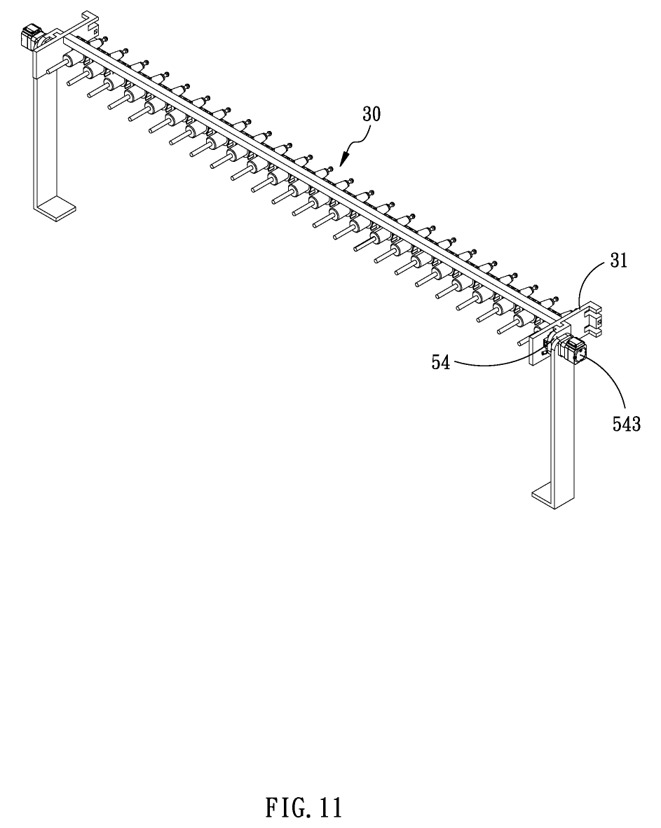

Referring to FIG. 10 and FIG. 11, a rotation driving device 543 is allowed to be added to the engagement frame 54 to rotate the tool holder 30, so as to achieve a multi-angle tool changing operation. Accordingly, the tool clamps 32 and machining tools 90 on the tool holder 30 are able to be arranged according to the architectures of the machine, without being restricted to the vertical direction. By using the rotation driving device 543 to rotate the tool holder 30 on the tool changing device 50, the tool changing direction of the spindle 13 is satisfied, providing greater flexibility of the present disclosure and allowing the application to a wider variety of machine tool 10 architectures.

Further, arrangement between the first tool storage area 21 and the second tool storage area 22 of the present disclosure may also be interchanged, such that the second tool storage area 22 is arranged closer to the spindle 13 than the first tool storage area 21. By simply changing the movement path of the tool changing device 50, the same objectives and effects can also be achieved.

With the foregoing configuration, the present disclosure achieves following technical features.

By storing the tool holders 30 in the first tool storage area 21 and the second tool storage area 22 in a stacked manner, in combination with the vertical movement seat 42, the locking device 43, and the power locking device 44 of the tool storage vertical movement device 40, the present disclosure effectively controls the switching of the tool holders 30 in the tool storage device 20. Accordingly, a simple and reliable tool storage method is provided, without the need of a complex structure or high precision control, thereby reducing the setup cost of the tool magazine.

Through the parallel arrangement of the tool holder returning position 211 and the tool holder picking position 221, the tool changing device 50 is configured to quickly complete the exchange operation of the unused tool holder 30B and the used tool holder 30A, thereby reducing tool changing time.

The tool storage horizontal movement device 23 is configured to switch the tool holders 30 between the first tool storage area 21 and the second tool storage area 22 via the communicating upper ends of the first tool storage area 21 and the second tool storage area 22. Such a method allows the tool holders 30 holding the unused tools to be pre-stored in first tool storage area 21, and to be sequentially exchanged to the second tool storage area 22 during tool change operations. Accordingly, the present disclosure increases the storage capacity of the tool holders 30. Further, the tool holders 30 are allowed to be arranged in staggered upper and lower layers to reduce the height of the tool storage device 20, thereby increasing tools storage capacity.

By equipping the engagement frame 54 of the tool changing device 50 with the rotation driving device 543, the present disclosure achieves a multi-angle tool changing operation, further enhancing the versatility and flexibility of the present disclosure.

The tool holders 30 are allowed to accommodate tool clamps 32 with identical or different specifications according to practical requirements, so as to fix machining tools 90 of identical or different specifications thereon.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A tool magazine system, which is applied to a machine tool having at least one spindle and a working area, with a tool changing position formed below the spindle in the working area, the tool magazine system comprising:
a tool storage device, comprising at least one first tool storage area and at least one second tool storage area, the first tool storage area and the second tool storage area being arranged in parallel, each of the first tool storage area and the second tool storage area being configured to accommodate a plurality of tool holders in a stacked manner, a lower end of the first tool storage area forming a tool holder returning position, a lower end of the second tool storage area forming a tool holder picking position; and
at least one tool storage vertical movement device, configured to drive the tool holders in the first tool storage area and second tool storage area to perform vertical movement, so as to deliver the tool holders from the tool holder returning position into the first tool storage area, and deliver the tool holders from the second tool storage area to the tool holder picking position, thereby allowing a tool changing device to transport the tool holders between the tool changing position, the tool holder returning position, and the tool holder picking position.

2. The tool magazine system of claim 1, wherein an upper end of the first tool storage area and an upper end of the second tool storage area are in communication with each other, with a tool storage horizontal movement device provided thereon; the tool storage horizontal movement device is configured to drive the tool holders to move at the upper ends of the first tool storage area and the second tool storage area.

3. The tool magazine system of claim 2, wherein the tool storage horizontal movement device comprises a horizontal movement power cylinder; the horizontal movement power cylinder has an actuating rod connected thereto; the actuating rod is configured to drive the tool holders to move at the upper ends of the first tool storage area and the second tool storage area that are in communication with each other.

4. The tool magazine system of claim 1, further comprising a frame, which is disposed to cover an outer periphery of the first tool storage area and the second tool storage area; the frame comprising at least one first clearance groove and at least one second clearance groove disposed on a lateral side of the first tool storage area and the second tool storage area.

5. The tool magazine system of claim 4, wherein each of the tool holders comprises a seat body disposed on two sides thereof, and a plurality of tool clamps disposed between the seat bodies; each of the tool clamp is configured to movably fix a machining tool thereon; the tool clamps are allowed to be a same or different specifications according to actual requirements, so as to fix machining tools of a same or different specifications.

6. The tool magazine system of claim 5, wherein the seat body comprises an engagement protrusion, at least one locking hole, and at least one actuating block, wherein the engagement protrusion has at least one protrusion latching hole and a retaining hole.

7. The tool magazine system of claim 6, wherein the tool storage vertical movement device comprises at least one driving cylinder, and a vertical movement seat driven by the driving cylinder to perform vertical movement; the vertical movement seat is disposed adjacent to the first clearance groove and the second clearance groove.

8. The tool magazine system of claim 7, wherein an extension block is disposed on the vertical movement seat corresponding to the first clearance groove; the extension block is configured to extend from the first clearance groove into the first tool storage area to movably abut against the actuating block of the tool holder.

9. The tool magazine system of claim 8, wherein the frame comprises at least one locking device disposed on a lateral side of the first tool storage area; the locking device is configured to movably engage the locking hole of one of the tool holders in the first tool storage area; the locking device is an elastically retractable wedge block device.

10. The tool magazine system of claim 7, wherein the vertical movement seat comprises a power locking device disposed corresponding to the second clearance groove; the power locking device is a power cylinder having a shaft end configured to extend from the second clearance groove to movably engage the locking hole of one of the tool holders in the second tool storage area.
